(19) United States
(12) Patent Application Publication
(10) Pub. No.: US 2019/0170013 A1
(43) Pub. Date: Jun. 6, 2019

(54) Discontinuous Molded Tape Wear Interface for Composite Components

(71) Applicant: General Electric Company, Schenectady, NY (US)

(72) Inventor: Christopher Paul Tura, Nahant, MA (US)

(21) Appl. No.: 15/833,201

(22) Filed: Dec. 6, 2017

(51) Int. Cl. F01D 25/00; B32B 5/12; B32B 3/10; B32B 18/00; C04B 35/71; C04B 41/50; C04B 41/87; C04B 41/00; C04B 37/00

(52) U.S. Cl. CPC F01D 25/005; B32B 5/12; B32B 3/10; B32B 18/00; F01D 5/288; C04B 41/50; C04B 41/87; C04B 41/009; C04B 37/001; C04B 35/71

(57) ABSTRACT

Composite components that include features that provide improved wear characteristics at the interface between the composite component and a second component are provided. As one example, a composite component can include an integrally formed discontinuous molded tape (DMT) that defines a wear interface between the component and a second component. The wear interface defined by the DMT may provide improved durability of the composite component and may facilitate more uniform wear at the interface, among other benefits. Methods for manufacturing composite components having discontinuous molded tape wear interfaces are also provided.

### FIELD

The present subject matter relates generally to composite components for gas turbine engines. More particularly, the present subject matter relates to composite components having discontinuous molded tape wear interfaces and methods for manufacturing the same.

### BACKGROUND

A gas turbine engine generally includes a fan and a core arranged in flow communication with one another. Additionally, the core of the gas turbine engine general includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the turbine section drives the turbine section and is then routed through the exhaust section, e.g., to atmosphere.

More commonly, non-traditional high temperature materials, such as ceramic matrix composite (CMC) materials, are being used for various components within gas turbine engines. As CMC materials can withstand relatively extreme temperatures, there is particular interest in replacing components formed of traditional materials within the flow path of the combustion gases with CMC materials. For instance, nozzles, rotor blades, and shrouds of the turbine section of the gas turbine engine are more commonly being formed of CMC materials. As another example, combustion liners of the combustion section are also more commonly being formed of CMC materials. Such CMC components or laminates are generally formed of a plurality of unidirectional plies each formed of a reinforcement material (e.g., fibers) embedded within a ceramic matrix.

Within a gas turbine engine, certain CMC components may interface with components formed of other materials, such as e.g., metallic components. For example, a CMC shroud of the turbine section may interface directly with a metallic pin to couple the shroud with a hanger. As another example, a CMC shroud may interface with a metallic bushing or grommet that in turn interfaces with a metallic pin to couple the shroud with a hanger. Interfacing metallic components with CMC components presents a number of challenges. For instance, due to their laminate construction, CMC components can have anisotropic wear characteristics at the CMC-metallic interface, and thus, interface loads are generally not applied over the thickness of the CMC component. This may cause non-uniform wear along the interface, for example. Moreover, CMC components typically have relatively low laminar stress capability at their edges, making the underlying plies of the CMC susceptible to edge loaded chipping and ply delamination. Metallic bushing or grommets have been implemented to address these issues, but they drive a significant space claim and increase complexity and cost. Moreover, metallic bushings or grommets also typically interface directly with the underlying structural plies and thus many of the same challenges may persist.

Accordingly, composite components, such as e.g., CMC components, that include features that address one or more of the noted challenges would be useful. In particular, a composite component that includes features that improve the wear interface characteristics of the composite component, among other things, would be beneficial.

### BRIEF DESCRIPTION

Aspects and advantages of the invention will be set forth in part in the following description, or may be obvious from the description, or may be learned through practice of the invention.

In one exemplary embodiment, a component for a gas turbine engine is provided. The component includes a structural laminate formed of a plurality of plies comprised of reinforcement fibers embedded within a matrix material. Moreover, the component includes a discontinuous molded tape (DMT) attached to the structural laminate and comprising a plurality of reinforcement fragments embedded within a matrix material, wherein the DMT defines a wear interface.

In another exemplary embodiment, a method for manufacturing a composite component is provided. The method includes laying up one or more plies to form a structural laminate, the one or more plies comprised of reinforcement fibers embedded within a matrix material. In addition, the method includes attaching a discontinuous molded tape (DMT) to the structural laminate, the DMT comprised of a plurality of reinforcement fragments embedded within a matrix material, wherein the DMT defines a wear interface.

In another exemplary embodiment, a method for manufacturing a ceramic matrix composite (CMC) component for a gas turbine engine is provided. The CMC component includes a structural laminate comprised of one of more unidirectional plies. The method includes attaching a discontinuous molded tape (DMT) to the structural laminate, the DMT comprised of a plurality of reinforcement fragments embedded within a matrix material. Further, the method includes curing the structural laminate and the DMT so as to integrally form the DMT with the structural laminate, wherein the DMT defines a wear interface.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a schematic cross-sectional view of an exemplary gas turbine engine according to various embodiments of the present disclosure;

FIG. 2 provides an exemplary shroud hanger assembly of the gas turbine engine of FIG. 1;

FIG. 3 provides a close up view of Section 3 of FIG. 2 depicting a discontinuous molded tape defining a wear interface of a shroud of the shroud hanger assembly;

FIG. 4 an axial forward-looking-aft view of two wear interfaces depicted as bushings according to various embodiments of the present disclosure;

FIG. 5 provides a close up view of one exemplary embodiment of a wear interface defined by a discontinuous molded tape (DMT) according to various embodiments of the present disclosure;

FIG. 6 provides a close up view of another exemplary embodiment of a wear interface according to various embodiments of the present disclosure;

FIGS. 7 and 8 provide yet another example of a CMC component that includes a wear interface defined by a DMT that is configured to interface with a second component according to various embodiments of the present disclosure;

FIG. 9 provides a flow diagram of an exemplary method according to an exemplary embodiment of the present disclosure; and

FIG. 10 provides a flow diagram of another exemplary method according to an exemplary embodiment of the present disclosure.

Repeat use of reference characters in the present specification and drawings is intended to represent the same or analogous features or elements of the present invention.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows and “downstream” refers to the direction to which the fluid flows. “HP” denotes high pressure and “LP” denotes low pressure.

Exemplary aspects of the present disclosure are directed to composite components that include features that provide improved wear characteristics at the interface between the composite component and a second component. As one example, a ceramic matrix composite (CMC) component can include an integrally formed discontinuous molded tape (DMT) that defines a wear interface between the CMC component and a second component, such as e.g., a pin formed of a metallic material. The DMT can be formed of a plurality of discontinuous reinforcement fragments embedded within a matrix material. The wear interface defined by the DMT may provide improved durability of the CMC component and may facilitate more uniform wear at the interface, among other benefits. Methods for manufacturing composite components having discontinuous molded tape wear interfaces are also provided.

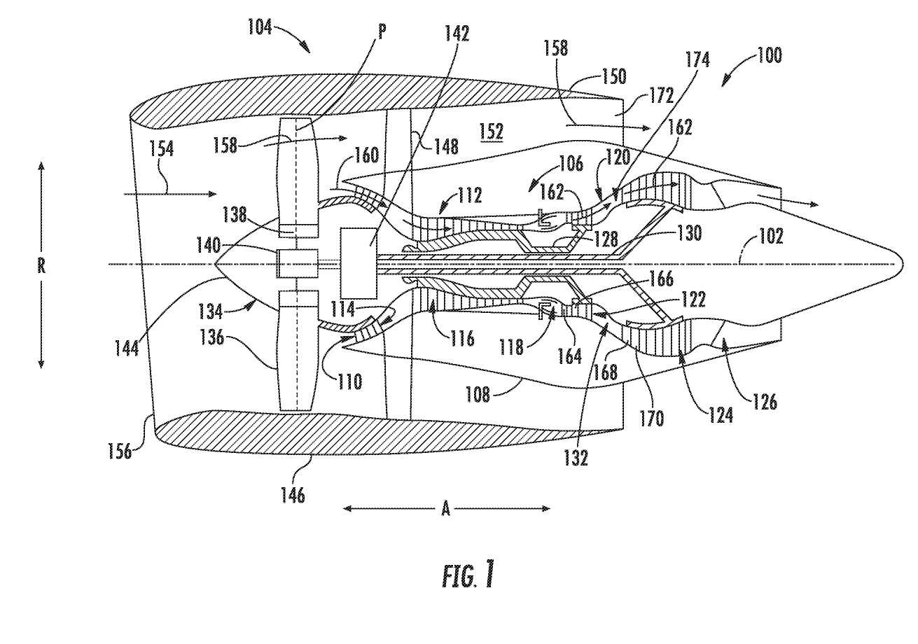

FIG. 1 is a schematic cross-sectional view of a gas turbine engine 100 in accordance with an exemplary embodiment of the present disclosure. More particularly, for the embodiment of FIG. 1, the gas turbine engine 100 is an aeronautical, high-bypass turbofan jet engine configured to be mounted to an aircraft, such as in an under-wing configuration or tail-mounted configuration. As shown in FIG. 1, the gas turbine engine 100 defines an axial direction A (extending parallel to or coaxial with a longitudinal centerline 102 provided for reference), a radial direction R, and a circumferential direction C (i.e., a direction extending about the axial direction A; not depicted in FIG. 1). In general, the gas turbine engine 100 includes a fan section 104 and a core turbine engine 106 disposed downstream from the fan section 104.

The exemplary core turbine engine 106 depicted generally includes a substantially tubular outer casing 108 that defines an annular inlet 110. The outer casing 108 encases, in serial flow relationship, a compressor section 112 including a booster or LP compressor 114 and an HP compressor 116; a combustion section 118; a turbine section 120 including an HP turbine 122 and a LP turbine 124; and a jet exhaust nozzle section 126. An HP shaft or spool 128 drivingly connects the HP turbine 122 to the HP compressor 116. An LP shaft or spool 130 drivingly connects the LP turbine 124 to the LP compressor 114. The compressor section, combustion section 118, turbine section, and jet exhaust nozzle section 126 together define a core air flowpath 132 through the core turbine engine 106.

Referring still the embodiment of FIG. 1, the fan section 104 includes a variable pitch fan 134 having a plurality of fan blades 136 coupled to a disk 138 in a circumferentially spaced apart manner. As depicted, the fan blades 136 extend outwardly from disk 138 generally along the radial direction R. Each fan blade 136 is rotatable relative to the disk 138 about a pitch axis P by virtue of the fan blades 136 being operatively coupled to a suitable actuation member 140 configured to collectively vary the pitch of the fan blades 136, e.g., in unison. The fan blades 136, disk 138, and actuation member 140 are together rotatable about the longitudinal centerline 102 by LP shaft 130 across a power gear box 142. The power gear box 142 includes a plurality of gears for stepping down the rotational speed of the LP shaft 130 to a more efficient rotational fan speed.

Referring still to the exemplary embodiment of FIG. 1, the disk 138 is covered by rotatable front nacelle 144 aerodynamically contoured to promote an airflow through the plurality of fan blades 136. Additionally, the exemplary fan section 104 includes an annular fan casing or outer nacelle 146 that circumferentially surrounds the fan 134 and/or at least a portion of the core turbine engine 106. Moreover, for the embodiment depicted, the nacelle 146 is supported relative to the core turbine engine 106 by a plurality of circumferentially spaced outlet guide vanes 148. Further, a downstream section 150 of the nacelle 146 extends over an outer portion of the core turbine engine 106 so as to define a bypass airflow passage 152 therebetween.

During operation of the gas turbine engine 100, a volume of air 154 enters the gas turbine engine 100 through an associated inlet 156 of the nacelle 146 and/or fan section 104. As the volume of air 154 passes across the fan blades 136, a first portion of the air 154 as indicated by arrows 158 is directed or routed into the bypass airflow passage 152 and a second portion of the air 154 as indicated by arrow 160 is directed or routed into the LP compressor 114. The pressure of the second portion of air 160 is then increased as it is routed through the high pressure (HP) compressor 116 and into the combustion section 118.

Referring still to FIG. 1, the compressed second portion of air 160 from the compressor section mixes with fuel and is burned within the combustion section 118 to provide combustion gases 162. The combustion gases 162 are routed from the combustion section 118 along the hot gas path 174, through the HP turbine 122 where a portion of thermal and/or kinetic energy from the combustion gases 162 is extracted via sequential stages of HP turbine stator vanes 164 that are coupled to the outer casing 108 and HP turbine rotor blades 166 that are coupled to the HP shaft or spool 128, thus causing the HP shaft or spool 128 to rotate, thereby supporting operation of the HP compressor 116. The combustion gases 162 are then routed through the LP turbine 124 where a second portion of thermal and kinetic energy is extracted from the combustion gases 162 via sequential stages of LP turbine stator vanes 168 that are coupled to the outer casing 108 and LP turbine rotor blades 170 that are coupled to the LP shaft or spool 130, thus causing the LP shaft or spool 130 to rotate, thereby supporting operation of the LP compressor 114 and/or rotation of the fan 134.

The combustion gases 162 are subsequently routed through the jet exhaust nozzle section 126 of the core turbine engine 106 to provide propulsive thrust. Simultaneously, the pressure of the first portion of air 158 is substantially increased as the first portion of air 158 is routed through the bypass airflow passage 152 before it is exhausted from a fan nozzle exhaust section 172 of the gas turbine engine 100, also providing propulsive thrust. The HP turbine 122, the LP turbine 124, and the jet exhaust nozzle section 126 at least partially define a hot gas path 174 for routing the combustion gases 162 through the core turbine engine 106.

It will be appreciated that the exemplary gas turbine engine 100 depicted in FIG. 1 is by way of example only, and that in other exemplary embodiments, the gas turbine engine 100 may have other suitable configurations. Additionally, or alternatively, aspects of the present disclosure may be utilized with any other suitable aeronautical gas turbine engine, such as a turboshaft engine, turboprop engine, turbojet engine, etc. Further, aspects of the present disclosure may further be utilized with industrial and marine gas turbine engines, and/or auxiliary power units.

Various components of the gas turbine engine 100 can be formed of a composite material. In particular, components within hot gas path 174, such as components of the combustion section 118, HP turbine 122, and/or LP turbine 124, can be formed of a ceramic matrix composite (CMC) material, which is a non-metallic material having high temperature capability. Exemplary CMC materials utilized for such components can include silicon carbide, silicon, silica, or alumina matrix materials and combinations thereof. Ceramic fibers can be embedded within the matrix, such as oxidation stable reinforcing fibers including monofilaments like sapphire and silicon carbide (e.g., Textron's SCS-6), as well as rovings and yarn including silicon carbide (e.g., Nippon Carbon's NICALON®, Ube Industries' TYRANNO®, and Dow Corning's SYLRAIVIIC®), alumina silicates (e.g., Nextel's 440 and 480), and chopped whiskers and fibers (e.g., Nextel's 440 and SAFFIL®), and optionally ceramic particles (e.g., oxides of Si, Al, Zr, Y, and combinations thereof) and inorganic fillers (e.g., pyrophyllite, wollastonite, mica, talc, kyanite, and montmorillonite). CMC materials may have coefficients of thermal expansion in the range of about 1.3×10⁻⁶ in/in/° F. to about 3.5×10⁻⁶ in/in/° F. in a temperature range of approximately 1000-1200° F.

Some CMC components of the gas turbine engine 100 may interface with components formed of other materials, such as e.g., metallic materials. For instance, CMC shrouds may interface with metallic pins, CMC airfoils may interface with a metallic band, portions of CMC nozzle segments may interface with a metallic support ring, CMC combustor liners may interface with metallic rings, among other possible CMC-metallic interfaces. When a metallic component interfaces directly with a CMC component, the CMC component can experience aggressive anisotropic wear, edge loaded chipping, and inter-ply delamination at the interface, which can directly impact the integrity and durability of the CMC component. In accordance with exemplary embodiments of the present disclosure, CMC components that include features that provide improved wear characteristics at such CMC-metallic wear interfaces are disclosed. Various examples are provided below.

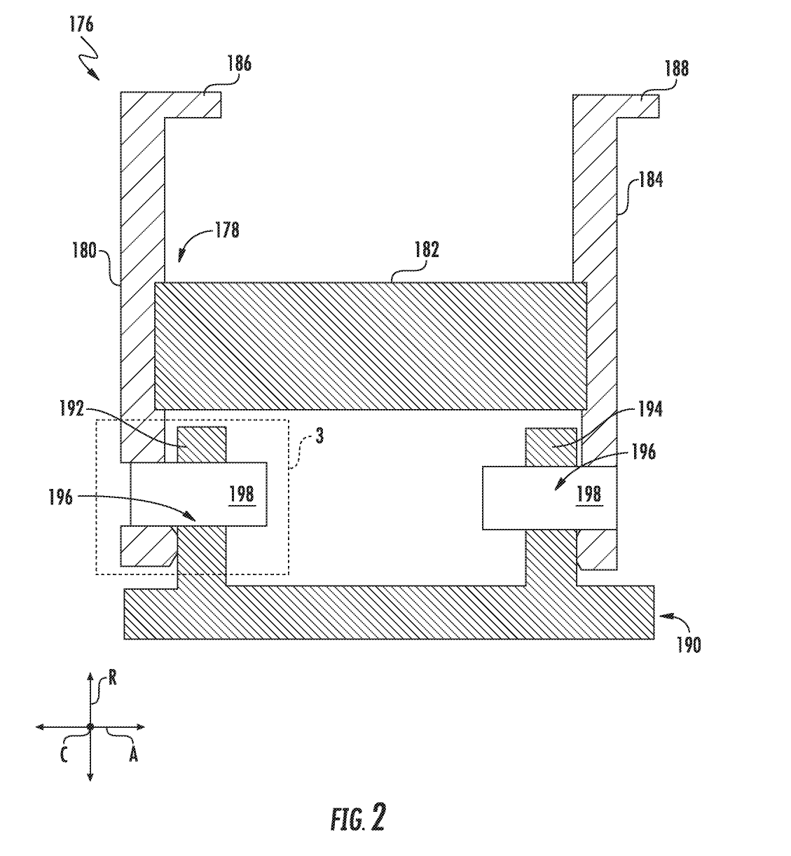

FIG. 2 provides an exemplary shroud hanger assembly 176 of the gas turbine engine 100 of FIG. 1. The shroud hanger assembly 176 includes a hanger 178 and a shroud 190. The hanger 178 can be formed of any suitable material, such as e.g., a high temperature nickel-based alloy. The shroud 190 can be formed of a suitable composite material. For this embodiment, the shroud 190 is formed of a CMC material. As shown, the hanger 178 includes a forward hanger 180, a mid hanger 182, and an aft hanger 184. The forward hanger 180 includes a forward arm 186 and the aft hanger 184 includes an aft arm 188. The forward arm 186 and the aft arm 188 are spaced apart from one another along the axial direction A and are each configured to secure the shroud hanger assembly 176 with a casing (not shown) of the gas turbine engine 100 (FIG. 1). Although the hanger 178 is shown as separate pieces in the depicted embodiment of FIG. 2, in alternative exemplary embodiments, the hanger 178 can be a single piece.

The shroud 190 is shown in FIG. 2 positioned outward of the turbine rotor blade 166 of the HP turbine 122 (FIG. 1) along the radial direction R. The shroud 190 is operatively coupled with the hanger 178. More particularly, the shroud 190 includes a forward flange 192 and an aft flange 194 spaced apart from the forward flange 192 along the axial direction A. The forward flange 192 and the aft flange 194 each define an opening 196. For this embodiment, the openings 196 are through holes. As shown in FIG. 2, metallic pins 198 extend through the openings 196 and couple the shroud 190 with the hanger 178. More specifically, one of the metallic pins 198 extends through the opening 196 of the forward flange 192 and couples the forward flange 192 with the forward hanger 180 and the mid hanger 182. Further, one of the metallic pins 198 extends through the opening 196 of the aft flange 194 and couples the aft flange 194 with the mid hanger 182 and the aft hanger 184. Although not shown, the forward and aft flanges 192, 194 may define other openings through which metallic pins may extend to further couple the hanger 178 with the shroud 190, e.g., at a location spaced apart from the metallic pins 198 shown in FIG. 2 along the circumferential direction C.

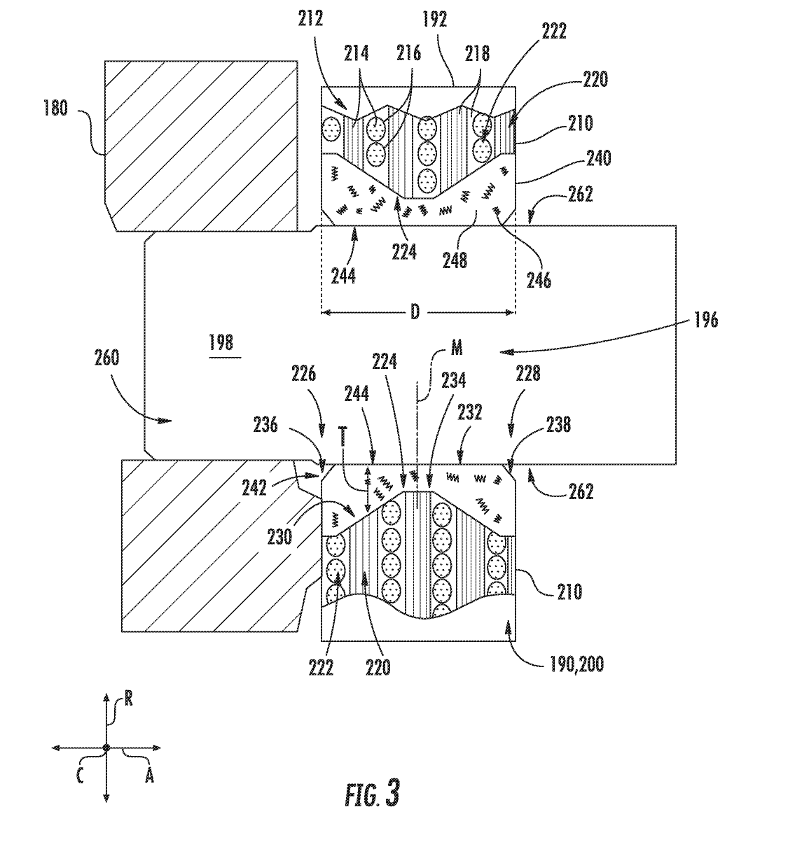

FIG. 3 provides a close up view of Section 3 of the shroud hanger assembly 176 of FIG. 2. More particularly, FIG. 3 provides a close up view of the CMC-metallic interface between a composite component 200 and a second component 260. For this embodiment, the composite component 200 is the shroud 190 and the second component 260 is the metallic pin 198 that couples the forward flange 192 with the forward hanger 180 and the mid hanger 182. Moreover, in FIG. 3, portions of the forward flange 192 radially outward of and radially inward of the opening 196 are cutaway so that the underlying structural laminate 210 that forms the forward flange 192 of the shroud 190 may be viewed.

As shown in FIG. 3, for this embodiment, the structural laminate 210 is formed of a plurality of plies 212 that each include a reinforcement material embedded within a matrix. More specifically, for this embodiment, each ply 212 of the structural laminate 210 is a unidirectional ply having a plurality of SiC filaments or fibers 214 bundled in tows 216 and embedded or encased within a SiC ceramic matrix 218 along a single direction. As depicted in FIG. 3, the structural laminate 210 is constructed with unidirectional plies 212 that have alternating fiber orientations. More specifically, the plies 212 include first plies 220 that have fibers 214 oriented along the radial direction R and second plies 222 that have fibers 214 oriented along the circumferential direction C. The second plies 222 alternate with the first plies 220 to form the structural laminate 210. In this way, structural laminate 210 has a bidirectional laminate construction.

As further shown in FIG. 3, a discontinuous molded tape (DMT) 240 is integrally formed with the structural laminate 210 and defines a wear interface 242. For this embodiment, the DMT 240 also further defines opening 196, as the added volume of DMT 240 decreases the diameter of the opening 196. The wear interface 242 is configured to interface with the second component 260, which as noted above, is metallic pin 198. The wear interface 242 is shown positioned between the structural laminate 210 and the second component 260 and is shown extending circumferentially about one or more surfaces 224 of the structural laminate 210 and along a depth D of the opening 196. In this way, for this embodiment, the wear interface 242 is a DMT bushing in this embodiment. It will be appreciated that the composite component 200 can include more than one DMT bushing. For instance, FIG. 4 provides an axial forward-looking-aft view of two wear interfaces 242 defined by DMTs 240 depicted as bushings.

Moreover, as shown in the depicted embodiment of FIG. 3, the DMT 240 is formed of a plurality of reinforcement fragments 246 embedded within a matrix material 248. For instance, the reinforcement fragments 246 can be ceramic fiber fragments, such as SiC fiber fragments, and the matrix material 248 of the DMT 240 can be any suitable matrix material, such as a SiC ceramic matrix material. Preferably, the matrix material 248 of the DMT 240 is formed of a matrix material that is compliant with the matrix material 218 of the plies 212 of the structural laminate 210. Although the reinforcement fragments 246 are shown as discontinuous fragments randomly arranged in matrix material 248 in FIG. 3, in alternative exemplary embodiments, the reinforcement fragments 246 can be discontinuous fibers arranged randomly within the matrix material 248. Further, in some embodiments, the reinforcement fragments 246 of the DMT 240 can include both discontinuous fragments and discontinuous fibers. The discontinuous fragments and fibers provide strength to the wear interface 242 yet still allow the wear interface 242 to have isotropic wear characteristics, which may lead to more uniform wear over the interface, among other benefits.

As further illustrated in FIG. 3, the wear interface 242 defined by the DMT 240 includes a wear surface 244 that is configured to interface with a wear surface 262 of the second component 260, which as noted above, is metallic pin 198 in this exemplary embodiment. During operation of the gas turbine engine 100 (FIG. 1), the metallic pin 198 and the forward flange 192 move relative to one another along the axial direction A and the circumferential direction C. As a result, the wear surface 244 of the wear interface 242 defined by the DMT 240 interfaces with the wear surface 262 of the metallic pin 198. Over time, the metallic pin 198 can wear the forward flange 192.

The wear interface 242 defined by the DMT 240 functions as a buffer or bridge between the metallic pin 198 and the laminate structure 210 of the forward flange 192 of the CMC shroud 190. Accordingly, the laminate structure 210 does not directly interface with the metallic pin 198, which protects the underlying laminate structure 210 and reduces the stress on the plies 212. In addition, as the DMT 240 that defines the wear interface 242 has isotropic wear properties, or wear properties that are the same or substantially the same in all directions, the wear interface 242 distributes the interface load across the thickness of the structural laminate 210 (in this embodiment, the thickness of the structural laminate extends along the axial direction A) and provides uniform multi-directional wear characteristics. In this way, the occurrence of edge-loading driven chipping and inter-ply delamination may be reduced.

More specifically, as shown in FIG. 3, as noted previously, the fibers 214 of the first plies 220 are oriented along the radial direction R and the fibers 214 of the second plies 222 are oriented along the circumferential direction C. Thus, the fibers 214 of the first and second plies 220, 222 are both orthogonal to the axial direction A. As such, without the DMT 240, the laminate structure 210 would be supported in the axial direction A only by matrix material 218. The DMT wear interface 242 provides additional structural support to the laminate structure 210 in the axial direction A, and due to its isotropic wear properties, the DMT wear interface 242 distributes the load over the axial thickness of the structural laminate 210, as opposed a point load at a single ply. Accordingly, the DMT wear interface 242 reduces the occurrence of inter-ply delamination and ply chipping.

Moreover, as the wear interface 242 defined by the DMT 240 is integrally formed with the laminate structure 210, the space claim is reduced and the CMC-metallic wear interface coupling is simplified. Stated differently, as the wear interface 242 defined by the DMT 240 has advantageous wear properties, a metallic bushing or grommet need not be inserted into opening 196 to support the metallic-CMC interface. Thus, the additional space needed for such metallic bushing or grommet to fit into the opening 196 is not needed.

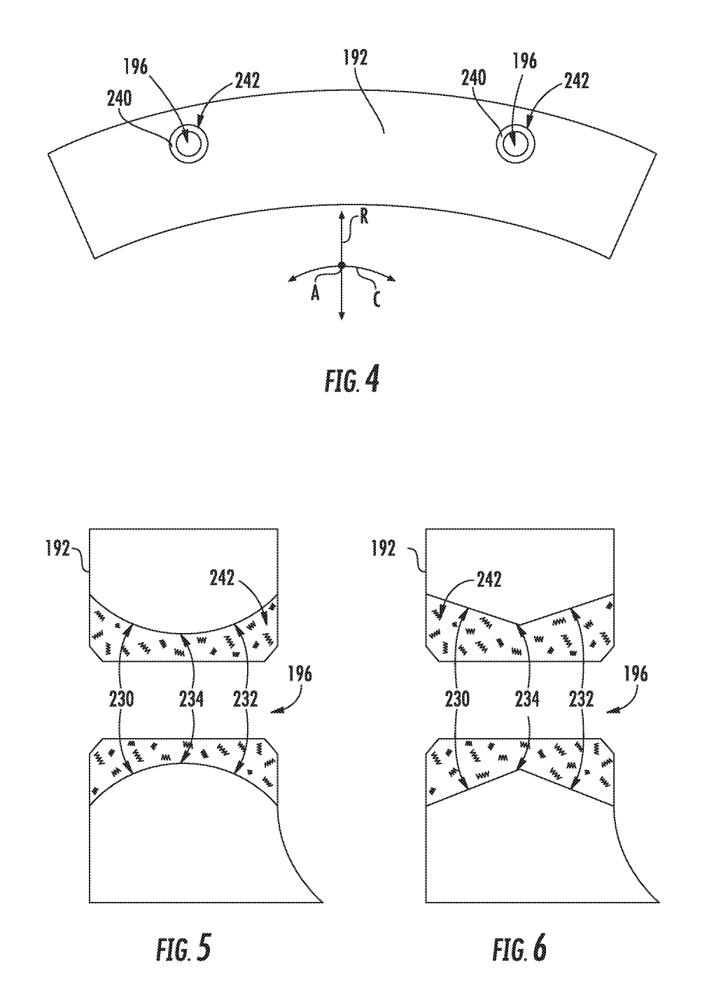

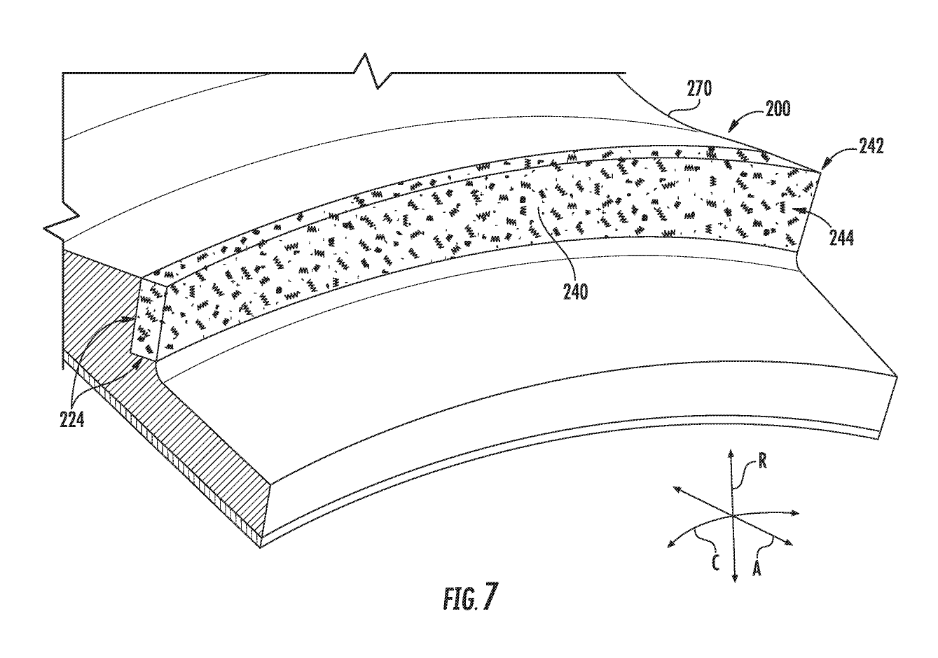

In some embodiments, for improved integration or bonding of the DMT 240 with the structural laminate 210, the opening 196 can be laid up or machined such that the surface area to which the DMT 240 can attach is increased. For example, as shown in FIG. 3, the one or more surfaces 224 of the structural laminate 210 to which the DMT 240 is integrally formed can include a first inclined surface 230, a second inclined surface 232, and a tip portion 234 connecting the first and second inclined surfaces 230, 232 along its circumferential cross section. The first and second inclined surfaces 230, 232 converge at the tip portion 234. Tip portion 234 is shown extending generally parallel to the wear surface 244 of the wear interface 242. Accordingly, for the depicted embodiment of FIG. 3, the wear interface 242 has a circumferential cross section that has an hour glass or butterfly wing shape. In some embodiments, the tip portion 234 may be rounded or pointed, for example, as shown in FIGS. 5 and 6, respectively. In yet other embodiments, the wear interface 242 defined by DMT 240 may have a circumferential cross section having other suitable geometries. By laying up or machining the surfaces 224 of the structural laminate 210 such that the structural laminate 210 has first and second inclined surfaces 230, 232, the surface area to which the DMT 240 can attach is increased, and thus, the integration or bonding of the DMT wear interface 242 to the structural laminate 210 may be improved.

Stated differently, as shown in FIG. 3, the opening 196 has a depth D that extends between a first end 226 and a second end 228. The wear interface extends between a first side 236 and a second side 238 along at least a portion of the depth D of the opening 196. For this embodiment, the wear interface 242 extends between the first end 226 and the second end 228 along substantially the entire depth D of the opening 196. A midline M is defined midway between the first side 236 and the second side 238 of the wear interface 242. Furthermore, as shown, the one or more surfaces 224 of the structural laminate 210 include one or more inclined surfaces that are inclined with respect to the wear surface 244 of the wear interface 242. More particularly, as noted above for the depicted embodiment of FIG. 3, the one or more inclined surfaces include a first inclined surface 230 and a second inclined surface 232 that are inclined with respect to the wear surface 244 and converge proximate the midline M at tip portion 234.

In some embodiments, the DMT wear interface 242 can have a greater thickness along certain portions of the depth D of the opening 196, e.g., to better protect certain portions of the underlying laminate structure 210 from being damaged as the wear interface 242 wears over time. For instance, as shown in FIG. 3, the wear interface 242 has a thickness T extending between the one or more surfaces 224 of the structural laminate 210 and the wear surface 244 of the wear interface 242 configured to interface with the second component 260. As shown, the thickness of the wear interface 242 is greater proximate at least one of the first side 236 and the second side 238 of the wear interface 242 than the thickness of the wear interface proximate the midline M. In this way, the wear interface 242 is reinforced with DMT 240 proximate at least one of its sides, which may be particularly advantageous where the wear interface 242 is likely to wear at its sides, such as in the present embodiment depicted in FIG. 3. As the metallic pin 198 wears the sides of the wear interface 242 over time, the increased thickness of the DMT wear interface 242 at one of its sides provides an extra buffer of protection so that the structural laminate 210 does not interface directly with the metallic pin 198. In some embodiments, the thickness of the wear interface 242 is greater proximate both the first side 236 and the second side 238 of the wear interface 242 than the thickness of the wear interface proximate the midline M.

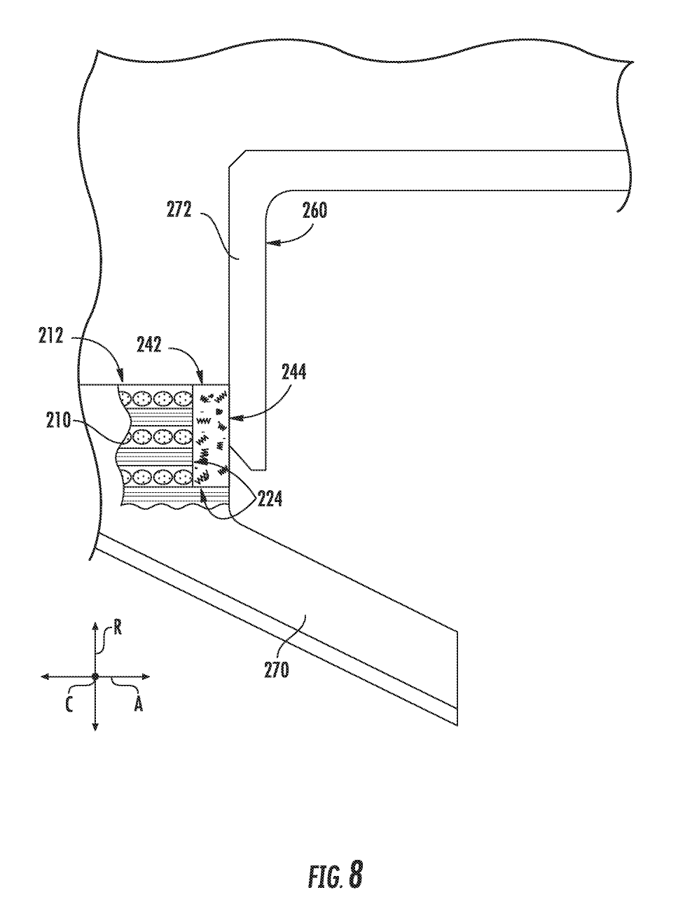

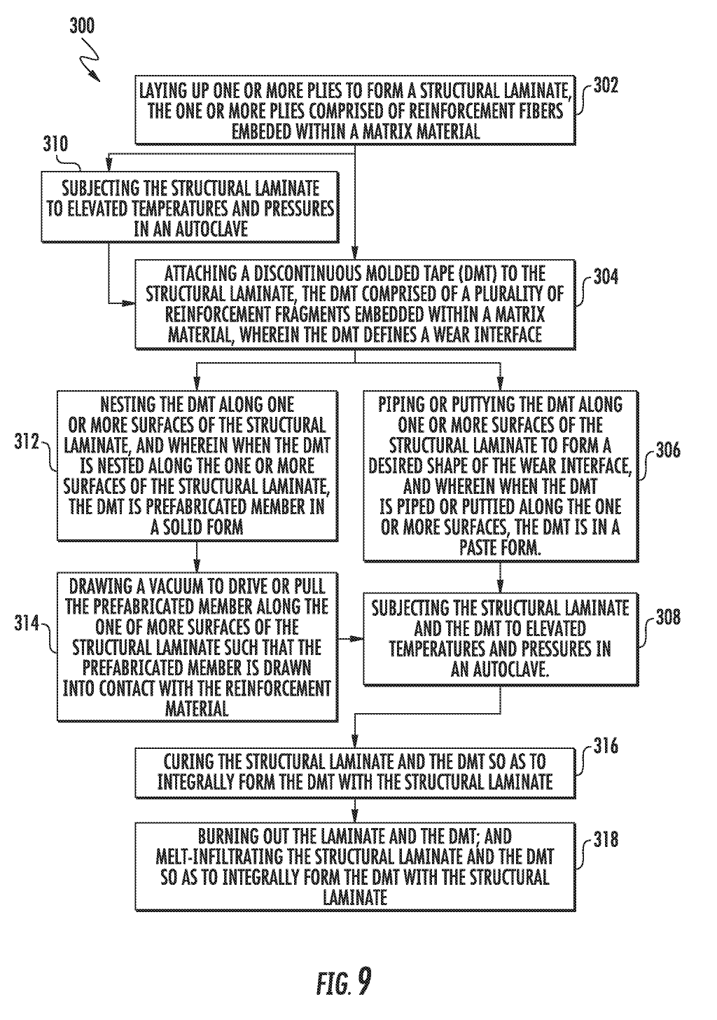

FIGS. 7 and 8 provide another example of a CMC component that includes a wear interface defined by a DMT that is configured to interface with a second component. More particularly, for this embodiment, the CMC component 200 is a combustion liner 270 and the second component 260 is a ring 272 (FIG. 8) formed of a metallic material. Further, for this embodiment, the wear interface 242 is a ring contact face of the combustion liner 270 that has advantageous wear properties as described above. The ring contact face or wear interface 242 is integrally formed with one or more surfaces 224 of the structural laminate 210. Moreover, in FIG. 8, a part of the combustor liner 270 is cutaway so that the underlying structural laminate 210 that forms the combustion liner 270 may be viewed.

During operation of a gas turbine engine (such as e.g., the gas turbine engine 100 of FIG. 1), the wear interface 242, or the ring contact face in this embodiment, interfaces with and moves relative to the metallic ring 272 or vice versa along the radial direction R and the circumferential direction C. As the wear interface 242 defined by the DMT 240 is positioned between the structural laminate 210 and the metallic ring 272, the metallic ring 272 does not interface directly with the structural laminate 210, thereby protecting the underlying plies 212 of the structural laminate 210. Moreover, as the DMT 240 has isotropic wear properties, the DMT wear interface 242 distributes the load over the thickness of the structural laminate 210, as opposed to a single ply. Accordingly, the DMT wear interface 242 reduces the occurrence of inter-ply delamination and ply chipping. Further, the wear interface 242 defined by the DMT 240 offers additional benefits, as described above.

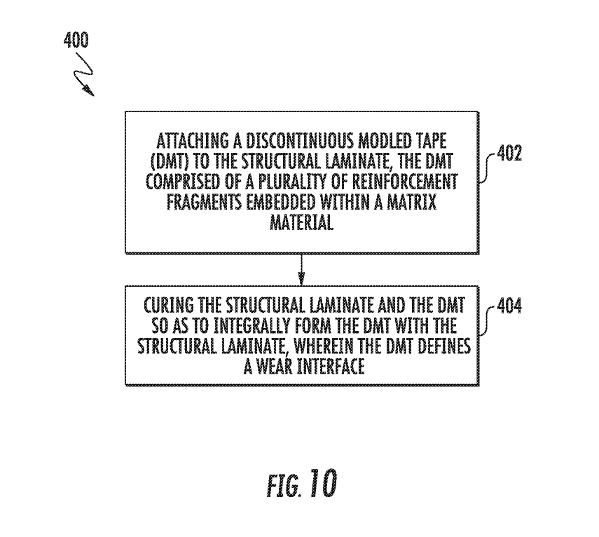

Exemplary methods for manufacturing components having DMT wear interfaces will now be provided. In particular, FIG. 9 provides a flow diagram of an exemplary method for manufacturing a composite component configured to interface with a second component. For instance, the component can be the shroud 190 of FIGS. 2 and 3 or the combustion liner 270 of FIGS. 7 and 8 illustrated and described herein. Moreover, the component can be another component of a gas turbine engine, such as e.g., the gas turbine engine 100 of FIG. 1. As yet another example, the component can be a CMC airfoil and the second component can be a metallic outer band. As a further example, the composite component can be formed of a polymer matrix composite (PMC) material and the second component can be a metallic component.

At (302), the method (300) includes laying up one or more plies to form a structural laminate, the one or more plies comprised of reinforcement fibers embedded within a matrix material. For instance, the one or more plies can be unidirectional plies. The reinforcement fibers can be bundled in tows. The matrix material can be a ceramic matrix material or another suitable matrix material, such as e.g., a polymer matrix material. As one example, the structural laminate can be one of the flanges 192, 194 of the shroud 190 of FIGS. 2 and 3. As another example, the structural laminate can be a portion of the combustion liner 270 of FIGS. 7 and 8.

At (304), the method (300) includes attaching a discontinuous molded tape (DMT) to the structural laminate, the DMT comprised of a plurality of reinforcement fragments embedded within a matrix material. In some implementations, the matrix material of the DMT is a ceramic matrix material or a pre-melt infiltrate matrix material, e.g., a ceramic matrix precursor. The reinforcement fragments can be discontinuous carbon fiber or silicon carbide fragments or can be discontinuous fibers randomly dispersed within the matrix material of the DMT.

In some implementations, as shown at (306), attaching the DMT to the structural laminate includes piping or puttying the DMT along one or more surfaces of the structural laminate to form a desired shape of the wear interface. For instance, the desired shape can be a DMT bushing, such as e.g., the DMT bushings shown in FIGS. 3 and 4. Further, when the DMT is piped or puttied along the one or more surfaces of the structural laminate, the DMT can be in a paste form so that the DMT can be shaped to the desired shape. After attaching the DMT to the structural laminate, as shown at (308), the method further includes subjecting the structural laminate and the DMT to elevated temperatures and pressures in an autoclave. Thus, in such implementations, the paste-like DMT is applied to the structural laminate of the component prior to subjecting the component and the applied DMT to elevated temperatures and pressures in an autoclave. Accordingly, the DMT can be applied to the structural laminate when the structural laminate is a preform or in a preform state.

In some implementations, the DMT is formed from waste materials of one or more previously formed composite components. For instance, a cured composite component can be finish machined via a grinding process to form the component to a desired geometry. The composite chips or swarf produced by the grinding operation are mixed with various machining cooling and/or lubrication liquids during grinding, resulting in a slurry composition. The composite pieces are then separated from the waste machining liquids. The composite pieces can include reinforcement, matrix, and/or a combination of reinforcement and matrix materials. Next, the CMC pieces can be embedded within a matrix material to form the DMT. The matrix material can be, for example, a SiC ceramic matrix material. Additional additives can be added to the DMT to adjust its composition and properties. For example, various solvents, such as isopropanol, can be added to the DMT material to adjust the viscosity of the DMT to the desired viscosity and content.

In some implementations, as shown at (310), after laying up the plies to form the structural laminate at (302), the method (300) further includes subjecting the structural laminate to elevated temperatures and pressures in an autoclave. As a result, the structural laminate is in the green state. Thereafter, the DMT can be applied to the structural laminate as shown at (304). As shown at (312), attaching the DMT to the structural laminate includes nesting the DMT along one or more surfaces of the structural laminate. When the DMT is nested along the one or more surfaces of the structural laminate, the DMT can be a prefabricated member in a solid or semi-solid form and can include a plurality of reinforcement fragments embedded within a matrix material. As one example, the prefabricated member can be a slug shaped as a hollow cylindrical component that can be press fit or interference fit into an opening. In this way, the prefabricated member can be a DMT bushing. As another example, the prefabricated member can be an elongated ring or ring segment configured to be press fit into a recess or along a notch of the composite component. For instance, the prefabricated member can be an elongated ring segment configured to be press fit into a recess or notch of a composite combustion liner.

In some implementations, as shown at (314), nesting the DMT along one or more surfaces of the structural laminate includes drawing a vacuum to drive or pull the prefabricated member along the one or more surfaces of the structural laminate such that the prefabricated member is drawn into contact with the reinforcement material. During the vacuum draw or thereafter, the prefabricated member and the structural laminate can be subjected to elevated temperatures and pressures in the autoclave, as shown at (308). Further, in such implementations, the matrix material of the prefabricated member can be formed of a ceramic matrix material. In such implementations, when the prefabricated member is nested along the one or more surfaces of the structural laminate, the prefabricated member is a green state prefabricated member. That is, the prefabricated member has been subjected to elevated temperatures and pressures in an autoclave but has not undergone a firing process.

At (316), the method (300) includes curing the structural laminate and the DMT so as to integrally form the DMT with the structural laminate, wherein the DMT defines a wear interface configured to interface with the interface member. In some implementations, as shown at (318), curing includes burning out the laminate and the DMT and melt-infiltrating the structural laminate and the DMT so as to integrally form the DMT with the structural laminate.

As one example, for CMC components, after processing the structural laminate and the applied DMT in an autoclave to subject them to elevated temperatures and pressures to produce a compacted green state laminate, the green state laminate can be placed in a furnace to burn out excess binders or the like and then can be placed in a furnace with a piece or slab of silicon and fired to melt infiltrate the structural laminate with at least silicon. More particularly, heating (i.e., firing) the green state structural laminate and applied DMT in a vacuum or inert atmosphere decomposes the binders, removes the solvents, and converts the precursor to the desired pyrolyzed material. The decomposition of the binders results in a porous pyrolyzed body. The body may thereafter undergo densification, e.g., melt infiltration (MI), to fill the porosity. In one example, where the pyrolyzed component is fired with silicon, the component can undergo silicon melt-infiltration. However, densification can be performed using any known densification technique including, but not limited to, Silcomp, melt infiltration (MI), chemical vapor infiltration (CVI), polymer infiltration and pyrolysis (PIP), and oxide/oxide processes, and with any suitable materials including but not limited to silicon. In one embodiment, densification and firing may be conducted in a vacuum furnace or an inert atmosphere having an established atmosphere at temperatures above 1200° C. to allow silicon or other appropriate material or combination of materials to melt-infiltrate into the component.

Thereafter, the densified laminate and now integrally formed DMT can be finish machined as necessary. For instance, the laminate and/or the DMT can be grinded or otherwise machined, e.g., to bring the laminate and/or the DMT within tolerance and to the desired shape. It will be appreciated that other methods for curing the structural laminate and applied DMT are possible.

In some implementations, after laying up the one or more plies to form the structural laminate, the method (300) further includes machining an opening into the structural laminate, wherein the opening machined into the structural laminate is defined by one or more surfaces of the structural laminate, and wherein the opening has a depth extending between a first end and a second end. In such implementations, during attaching, the DMT is applied to the one or more surfaces of the structural laminate to further define the opening and such that the wear interface extends between a first side and a second side along at least a portion of the depth of the opening. Moreover, a midline is defined between the first side and the second side. In addition, the wear interface has a thickness extending between the one or more surfaces of the structural laminate and a wear surface of the wear interface, and wherein the thickness of the wear interface is greater proximate at least one of the first side and the second side than the thickness of the wear interface proximate the midline. In yet other implementations, the thickness of the wear interface is greater proximate both the first and second sides than the thickness of the wear interface proximate the midline.

In some implementations, after laying up the one or more plies to form the structural laminate, the method (300) further includes machining an opening into the structural laminate. The opening machined into the structural laminate is defined by one or more surfaces of the structural laminate and has a depth extending between a first end and a second end. In addition, in such implementations, during attaching, the DMT is applied to the one or more surfaces of the structural laminate to further define the opening and such that the wear interface extends between a first side and a second side along at least a portion of the depth of the opening and wherein the wear interface has a thickness extending between the one or more surfaces of the structural laminate and a wear surface of the wear interface configured to interface with the second component, and wherein the one or more surfaces of the structural laminate include on or more inclined surfaces that are inclined with respect to the wear surface of the wear interface.

FIG. 10 provides a flow diagram of an exemplary method for manufacturing a CMC component for a gas turbine engine. The CMC component is configured to interface with a second component. The CMC component includes a structural laminate that includes one of more unidirectional plies. For instance, the CMC component can be the shroud 190 of FIGS. 2 and 3 or the combustion liner 270 of FIGS. 7 and 8 illustrated and described herein. Moreover, the component can be another component of a gas turbine engine, such as e.g., the gas turbine engine 100 of FIG. 1. The second component can be a metallic component, for example, such as metallic pin 198 of FIGS. 2 and 3.

At (402), the method includes attaching a discontinuous molded tape (DMT) to the structural laminate, the DMT comprised of a plurality of reinforcement fragments embedded within a matrix material. In some implementations, the matrix material is a ceramic matrix material or a pre-melt infiltrate matrix material, e.g., a ceramic matrix precursor. The matrix material of the DMT can alternatively be a matrix material that is compliant with the ceramic matrix material of the CMC component. The reinforcement fragments can be carbon fiber or silicon carbide fragments or can be discontinuous fibers randomly dispersed within the matrix material of the DMT.

At (404), the method includes curing the structural laminate and the DMT so as to integrally form the DMT with the structural laminate, wherein the DMT defines a wear interface configured to interface with the interface member. In some implementations, curing includes burning out the laminate and the DMT and melt-infiltrating the structural laminate and the DMT so as to integrally form the DMT with the structural laminate.

In some implementations of method (400), various aspects discussed above with regard to method (300) can be implemented in method (400).

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A component for a gas turbine engine, the component comprising:
a structural laminate formed of a plurality of plies comprised of reinforcement fibers embedded within a matrix material; and
a discontinuous molded tape (DMT) attached to the structural laminate and comprising a plurality of reinforcement fragments embedded within a matrix material, wherein the DMT defines a wear interface.

2. The component of claim 1, wherein the DMT is integrally formed with the structural laminate.

3. The component of claim 1, wherein the plurality of plies are unidirectional plies.

4. The component of claim 1, wherein a second component is configured to interface with the wear interface of the component.

5. The component of claim 4, wherein the structural laminate comprises one or more surfaces that define an opening, and wherein the wear interface defined by the DMT is integrally formed with the one or more surfaces of the structural laminate and further defines the opening, and wherein when the second component interfaces with the wear interface, the second component interfaces with the wear interface within the opening.

6. The component of claim 5, wherein the component is a shroud and the structural laminate is a flange of the shroud, and wherein the second component is a pin formed of a metallic material.

7. The component of claim 5, wherein the opening has a depth extending between a first end and a second end, and wherein the wear interface defined by the DMT extends between a first side and a second side along at least a portion of the depth of the opening, and wherein the wear interface defines a midline between the first side and the second side, and wherein the wear interface has a thickness extending between the one or more surfaces of the structural laminate and a wear surface of the wear interface, and wherein the thickness of the wear interface is greater proximate at least one of the first side and the second side than the thickness proximate the midline.

8. The component of claim 1, wherein a second component is configured to interface with the wear interface of the component, and wherein the component is a combustion liner and the wear interface defined by the DMT is integrally formed with one or more surfaces of the laminate structure of the combustion liner, and wherein the interface member is a ring formed of a metallic material.

9. A method for manufacturing a composite component, the method comprising:
laying up one or more plies to form a structural laminate, the one or more plies comprised of reinforcement fibers embedded within a matrix material; and
attaching a discontinuous molded tape (DMT) to the structural laminate, the DMT comprised of a plurality of reinforcement fragments embedded within a matrix material, wherein the DMT defines a wear interface.

10. The method of claim 9, wherein attaching comprises piping or puttying the DMT along one or more surfaces of the structural laminate to form a desired shape of the wear interface, and wherein when the DMT is piped or puttied along the one or more surfaces, the DMT is in a paste form.

11. The method of claim 10, wherein after attaching the DMT to the structural laminate, the method further comprises:
subjecting the structural laminate and the DMT to elevated temperatures and pressures in an autoclave.

12. The method of claim 9, wherein the method further comprises:
subjecting the structural laminate to elevated temperatures and pressures in an autoclave;
wherein, after subjecting, attaching the DMT to the structural laminate comprises nesting the DMT along one or more surfaces of the structural laminate, and wherein when the DMT is nested along the one or more surfaces of the structural laminate, the DMT is a prefabricated member in a solid form.

13. The method of claim 12, wherein nesting comprises:
drawing a vacuum to drive or pull the prefabricated member along the one or more surfaces of the structural laminate such that the prefabricated member is drawn into contact with the reinforcement material; and
subjecting the structural laminate and the prefabricated member to elevated temperatures and pressures in the autoclave.

14. The method of claim 13, wherein the matrix material of the prefabricated member is formed of a ceramic matrix material, and wherein when the prefabricated member is nested along the one or more surfaces of the structural laminate, the prefabricated member is a green state prefabricated member.

15. The method of claim 9, wherein the method further comprises:
curing the structural laminate and the DMT so as to integrally form the DMT with the structural laminate.

16. The method of claim 15, wherein curing comprises:
burning out the laminate and the DMT; and
melt-infiltrating the structural laminate and the DMT so as to integrally form the DMT with the structural laminate.

17. The method of claim 9, wherein, after laying up, the method further comprises:
machining an opening into the structural laminate, wherein the opening machined into the structural laminate is defined by one or more surfaces of the structural laminate, and wherein the opening has a depth extending between a first end and a second end;
wherein, during attaching, the DMT is applied to the one or more surfaces of the structural laminate to further define the opening and such that the wear interface extends between a first side and a second side along at least a portion of the depth of the opening, and wherein a midline is defined between the first side and the second side, and wherein the wear interface has a thickness extending between the one or more surfaces of the structural laminate and a wear surface of the wear interface, and wherein the thickness of the wear interface is greater proximate at least one of the first side and the second side than the thickness of the wear interface proximate the midline.

18. The method of claim 9, wherein, after laying up, the method further comprises:
machining an opening into the structural laminate, wherein the opening machined into the structural laminate is defined by one or more surfaces of the structural laminate, and wherein the opening has a depth extending between a first end and a second end;
wherein, during attaching, the DMT is applied to the one or more surfaces of the structural laminate to further define the opening and such that the wear interface extends between a first side and a second side along at least a portion of the depth of the opening and wherein the wear interface has a thickness extending between the one or more surfaces of the structural laminate and a wear surface of the wear interface, and wherein the one or more surfaces of the structural laminate include on or more inclined surfaces that are inclined with respect to the wear surface of the wear interface.

19. The method of claim 18, and wherein the one or more inclined surfaces include a first inclined surface and a second inclined surface that converge at a tip portion.

20. A method for manufacturing a ceramic matrix composite (CMC) component for a gas turbine engine, the CMC component comprising a structural laminate comprised of one of more unidirectional plies, the method comprising:
attaching a discontinuous molded tape (DMT) to the structural laminate, the DMT comprised of a plurality of reinforcement fragments embedded within a matrix material; and
curing the structural laminate and the DMT so as to integrally form the DMT with the structural laminate, wherein the DMT defines a wear interface.
